(19) United States
(12) Patent Application Publication
(10) Pub. No.: US 2008/0311893 A1
(43) Pub. Date: Dec. 18, 2008

(54) Method and Apparatus for Regulating Gambling Applications at a Mobile Device

(75) Inventors: Charles Liu, Chapel Hill, NC (US); Leland Scott Bloebaum, Cary, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 11/763,105

(22) Filed: Jun. 14, 2007

(51) Int. Cl. H04Q 7/22; A63F 9/24; H04Q 7/38

(52) U.S. Cl. 455/414.2; 463/40

(57) ABSTRACT

Methods and apparatus for controlling access to an online gambling activity are disclosed. In response to an access request from a mobile terminal, a game server sends a location request comprising an identifier associated with the mobile terminal to a location service and selectively initiates an online gambling activity based on a response to the location request.

### BACKGROUND

The present invention relates generally to gaming applications for wireless devices, and particularly relates to controlling access to online gambling applications by a mobile terminal, using geographic location information corresponding to the terminal.

The roll-out in recent years of enhanced data capabilities for wireless networks has resulted in an explosion of wireless applications available to users of mobile devices. Wireless users are now able to browse Internet pages on their wireless phones or wireless-equipped Personal Digital Assistants. Users can user their mobile devices to download music files, send digital photographs or video to friends, or to compose and read e-mail messages.

Mobile gaming in particular is an increasingly popular form of entertainment. Mobile gaming includes activities ranging from simple puzzle games to elaborate multi-player games, with the complexity and popularity of games increasing with the enhancements of wireless networks and improved capabilities of mobile devices. Indeed, as mobile devices become increasingly sophisticated, the mobile gaming experience available to mobile users promises to approach the online gaming experience available on high-speed wired networks.

One category of online gaming that has not been widely implemented for mobile devices is gambling. Online gambling is controversial, as the legality of gambling activities varies from country to country, and even from one region within a country to another. Even in jurisdictions where gambling is legal, mobile operators are reluctant to offer or permit mobile gambling services, because of the difficulty in ensuring that the activity remains confined to a particular jurisdiction. Accordingly, even though there is intense industry interest in wireless gambling applications, very little market development has occurred in this field.

### SUMMARY

Methods and apparatus for controlling access to an online gambling activity are disclosed. In response to an access request from a mobile terminal, a game server sends a location request comprising an identifier associated with the mobile terminal to a location service and selectively initiates an online gambling activity based on a response to the location request. In one or more embodiments, the response comprises geographic location information, and access to the online gambling activity is selectively permitted based on a comparison of the geographic location information to jurisdictional boundaries.

In the event that access to the requested online gambling activity is denied, compliance information may be sent to the mobile terminal. This compliance information may comprise directions to an alternate location where access to the gambling activity is permitted, or it may comprise suggestions for an alternative activity.

### BRIEF DESCRIPTION OF THE DRAWINGS

FIG. 1 illustrates a system for wireless online gambling according to one or more embodiments of the present invention.

FIG. 2 illustrates a method for controlling access to a gambling application.

FIG. 3 illustrates geographic location information plotted against exemplary jurisdictional boundaries.

FIG. 4 illustrates geographic location information plotted near a pre-determined reference point.

FIG. 5 illustrates a method for controlling access to a gambling application.

FIG. 6 illustrates another method for controlling access to a gambling application.

FIG. 7 illustrates another method for controlling access to a gambling application.

FIG. 8 illustrates a game server according to one or more embodiments of the present invention.

### DETAILED DESCRIPTION

The present invention is described below in reference to a wireless telecommunications system providing data services to a mobile device. Various systems providing voice and data services have been deployed, such as GSM networks (providing circuit-switched communications) and GPRS (providing packet-switched communications); still others are currently under development. These systems may employ any or several of a number of wireless access technologies, such as Time Division Multiple Access (TDMA), Code Division Multiple Access (CDMA), Frequency Division Multiple Access (FDA), Orthogonal Frequency Division Multiple Access (OFDMA), Time Division Duplex (TDD), and Frequency Division Duplex (FDD). The present invention is not limited to any specific type of wireless communications network or access technology.

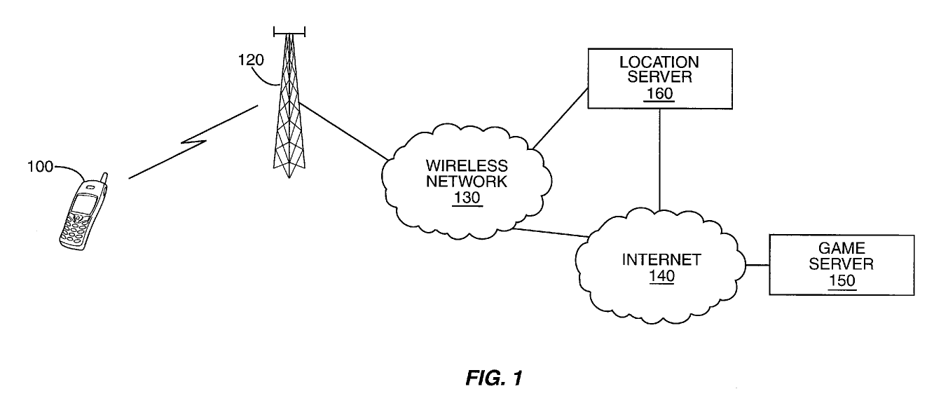

FIG. 1 presents an overview of a system for providing wireless access to online games, including online gambling activities. Mobile terminal 100 may be a wireless phone, a Personal Digital Assistant (PDA), a so-called smart phone, a laptop computer, or other similar device. Mobile terminal 100 communicates wirelessly with base station 120, which is connected to wireless network 130. Wireless network 130, base station 120 and mobile terminal 100 may conform to one or more of a variety of wireless standards, such as GSM/GPRS, CDMA, Wideband-CDMA, etc. Wireless network 130 provides mobile terminal 100 with voice communication as well as data communication services.

Among the data communication services provided to mobile terminal 100 is access to the Internet 140. Access to the Internet 130 may be provided by a wireless gateway (not shown), which adapts the wireless data services provided by wireless network 130 to include Internet access. Among the applications available to mobile terminal 100, then, are games made available by game server 150, which is connected to Internet 140 and thus accessible to mobile terminal 100.

Game server 150 is generally configured to provide online gambling applications, and in particular is configured to provide online gambling applications to mobile terminals such as mobile terminal 100. The gambling activities hosted by game server 150 may include any of a wide variety of games, including pure games of chance, such as simulated roulette and slot machines, and mixed games of chance and skill or strategy, such as poker and blackjack. Lotteries, sports betting, and pari-mutuel wagering are other activities that might be hosted by game server 150.

Because mobile terminal 100 may be located in a separate jurisdiction from game server 150, a different regulatory scheme may apply to mobile terminal 100. In other words, gambling activities which are permitted in the jurisdiction in which game server 150 is located may be illegal in the jurisdiction where mobile terminal 100 is located. Thus, game server 150 must only allow access to those applications to mobile terminals 100 located in jurisdictions that permit them.

Also connected to wireless network 130 is location server 160. Location server 160 is typically maintained by the operator of wireless network 130, but may be separately administered. The main function of location server 160 is to determine the geographic location of mobile terminals (such as mobile terminal 100) using the wireless network 130. Location information obtained by location server 160 may range from information identifying the cell currently serving mobile terminal 100 to more precise location information obtained using Global Positioning System (GPS) technology.

Other technologies, including triangulation methods exploiting signals transmitted from or received at several base stations, may also be used to obtain location information. Triangulation techniques may include Time Difference of Arrival (TDOA) technology, which utilizes measurements of a mobile's uplink signal at several base stations, or Enhanced-Observed Time Difference (E-OTD) technology, which utilizes measurements taken at the mobile terminal 100 of signals sent from several base stations. GPS-based technologies may include Assisted-GPS, which utilizes information about the current status of the GPS satellites derived independently of the mobile terminal 100 to aid in the determination of the terminal's location.

In fact, the location server 160 may have simultaneous access to several technologies. For example, cell-ID technology may be used to provide location information when a mobile terminal's on-board GPS receiver is unable to receive satellite signals. Alternatively, location information obtained by two or more techniques may be combined to form a refined estimate of the location of the mobile terminal 100.

In any event, the location server 160 provides location information designating a current position of mobile terminal 100 in terms of latitude and longitude, or in terms of a street address. Other representations of the mobile terminal's position are of course possible, such as a reference to a map page and/or grid number. In any case, since the location server 160 is often maintained by a wireless operator, access to the location information provided by location server 160 may be restricted. The administrator of location server 160 may charge fees for access to the location information, or may allow the location information to be obtained only for specific purposes or by specified partners or users.

When a mobile terminal 100 seeks access to the game server 150, location information provided by location server 160 is used by game server 150 to determine whether the user of mobile terminal 100 should be allowed to participate in the online gambling activities hosted by game server. This location information is used, for example, to determine whether the mobile terminal 100 is located in a jurisdiction where gambling activities are permitted, and thus whether access to a particular gambling activity should be permitted or denied.

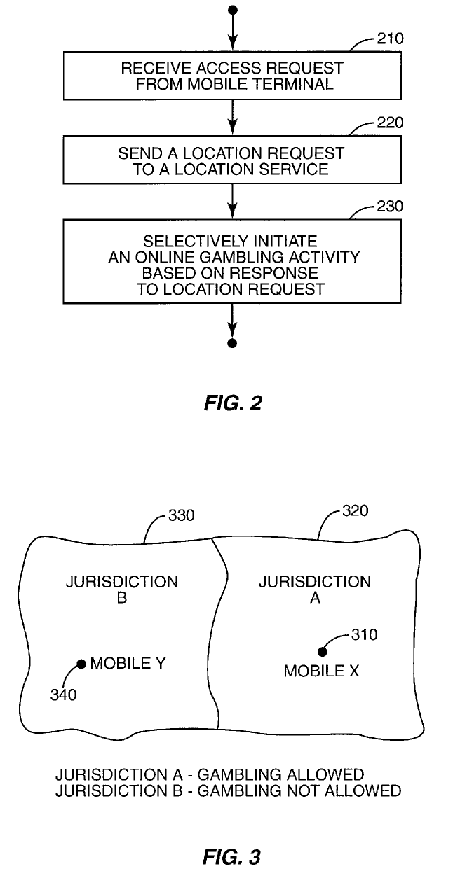

FIG. 2 illustrates an exemplary method according to the present invention. At block 210, a game server 150 receives a request for access to an online gambling activity from, e.g., mobile terminal 100. This request may be an initial attempt to access a web site associated with a variety of gambling activities hosted by the game server 150, or may be a request more specifically addressed to a particular gambling activity. For example, a mobile user may have already explored a gambling web site, registered for use, and selected a particular gambling activity. The “access request” of block 210 may then be a subsequent request to actually place a wager.

In any event, the access request received at block 210 triggers the game server to request the location of mobile terminal 100 from location server 160. This is illustrated at block 220 of FIG. 2. A message containing an identifier associated with the mobile terminal 100 is sent to the location server 160. The identifier, which may be a telephone number, electronic serial number, or the like, is used to uniquely identify the mobile terminal 100 to the location server 160. Location server 160, using one or more of the location determination technologies described above, determines the location of mobile terminal 100 and responds to the game server 150 with a message identifying the location.

At block 230, game server 150 selectively initiates the requested gambling activity based on the response from location server 160. In the usual case, the response from location server 160 comprises geographic location information, such as latitude and longitude coordinates. Game server 150 compares these coordinates to jurisdictional boundaries, e.g., a digital map, to determine the jurisdiction from which mobile terminal 100 made the access request. This digital map may include jurisdictional boundaries defined for cities, counties, states, or even countries. Once the game server 150 has determined the jurisdiction from which the mobile terminal 100 has connected, the game server 150 determines whether the requested activity is permitted in that jurisdiction.

The comparison of the received geographic location information to jurisdictional boundaries is illustrated in FIG. 3. Suppose that game server 150 is first accessed by Mobile X, which requests access to a gambling activity. After sending a location request to location server 160, game server 150 receives geographic location information corresponding to Mobile X's current location. This location is plotted in FIG. 3 at 310. Game server 150 also has access to jurisdictional boundaries, shown in FIG. 3 at 320 and 330, for Jurisdiction B and Jurisdiction A, respectively. Comparing geographic location information 310 to jurisdictional boundaries 320 and 330, game server 150 determines that Mobile X is located in Jurisdiction A, where gambling is permitted. Game server 150 thus permits Mobile X to access the requested gambling activity.

On the other hand, suppose that game server 150 is then accessed by Mobile Y, which requests access to the same gambling activity. After sending a location request, including an identifier for Mobile Y, to location server 160, game server 150 receives geographic location information for Mobile Y; this location is plotted in FIG. 3 at 340. Comparing geographic location 340 to jurisdictional boundaries 320 and 330, game server 150 determines that Mobile Y is located in Jurisdiction B, where gambling Is not allowed. Game server 150 thus does not permit Mobile Y to access the requested activity.

In the simplified example illustrated in FIG. 3, the differences in jurisdictional regulation between Jurisdictions A and B are stark: gambling is either allowed or disallowed. In some cases, a given jurisdiction may have more refined rules, permitting some activities while disallowing others. In such a case, jurisdictional boundaries are used in conjunction with corresponding rules to determine whether a particular gambling activity is permitted.

In FIG. 4, an alternative method is shown for determining whether access to a gambling activity should be granted. Suppose that Mobile Z requests access to a gambling activity hosted by game server 150. Using an identifier associated with Mobile Z, such as Mobile Z's telephone number, game server 150 sends a location request to location server 160. After receiving geographic location information for Mobile Z, which is plotted in FIG. 4 at 410, game server compares the geographic location information to a pre-determined reference point, determining the distance d between Mobile Z and the predetermined reference point. In FIG. 4, the predetermined reference point is plotted at 420.

Access to the gambling activity may be selectively granted based on the distance between the geographic location information 410 and the reference point 420. For example, the reference point may designate the center of a region in which online gambling activities are permitted. If Mobile Z is located within a certain range, perhaps 10 miles, of the reference point, then game server 150 may permit access. If Mobile Z is located further away, access is denied.

In certain situations, the same technique might be applied, but with a different rule. In this case, the reference point might designate the center of an isolated region in which gambling activities are not permitted. In this case, mobile terminals within a certain radius of the reference point are denied access, while those outside a predetermined radius are admitted. In either event, the approach illustrated in FIG. 4 simplifies the access determination performed by game server 150, as a comparison of the geographic location information with jurisdictional boundaries is not required.

The preceding discussion assumed that location server 160 provided geographic coordinates, e.g. latitude and longitude, to game server 150. Other representations of geographic position are possible. For example, location server 160 may be configured to provide street address information instead of, or in addition to, the geographic coordinates. The street address information may then be compared to a database to determine which jurisdiction mobile terminal 100 is connecting from, or whether mobile terminal 100 is located within a particular jurisdiction. In yet another alternative, location server 160 may be configured to provide a map page and/or grid number, corresponding to a predetermined map, indicating the geographic position of mobile terminal 100. This information may then be compared to a list or range of map pages and/or grid numbers to determine whether mobile terminal 100 is located in a jurisdiction where online gambling activities are permitted.

In yet another embodiment, the location request sent from game server 150 to location server 160 might include geographic limits. In this case, the response from location server 160 might be as simple as a “yes” or “no” message, indicating whether mobile terminal 100 is currently located inside or outside the geographical limits. For example, the location request sent to location server 160 might include a geographic limit parameter indicating “Nevada.” In this case, the location server 160 simply responds with a code indicating whether or not mobile terminal 100 is located in Nevada. Determination of whether mobile terminal 100 should be permitted access to the requested gambling activity is then based on this response.

Alternatively, the geographic limits included in the location request might comprise a geometrically defined boundary, for example, a boundary defined by one or more polygons. As with the previous embodiment, the response from the location server 160 might in this case simply comprise a parameter indicating whether or not mobile terminal 100 is located inside the defined boundary.

In certain circumstances the location request sent from game server 150 to location server 160 might be rejected. This could occur for a variety of reasons. For example, location server 160 might restrict location information to certain partners or users; game server 150 may not be among the allowed users. Alternatively, location server 160 might require that the owner of mobile terminal 100 specifically authorize the release of location information to third parties. If the owner does not authorize that release, then a location request from game server 150 is denied.

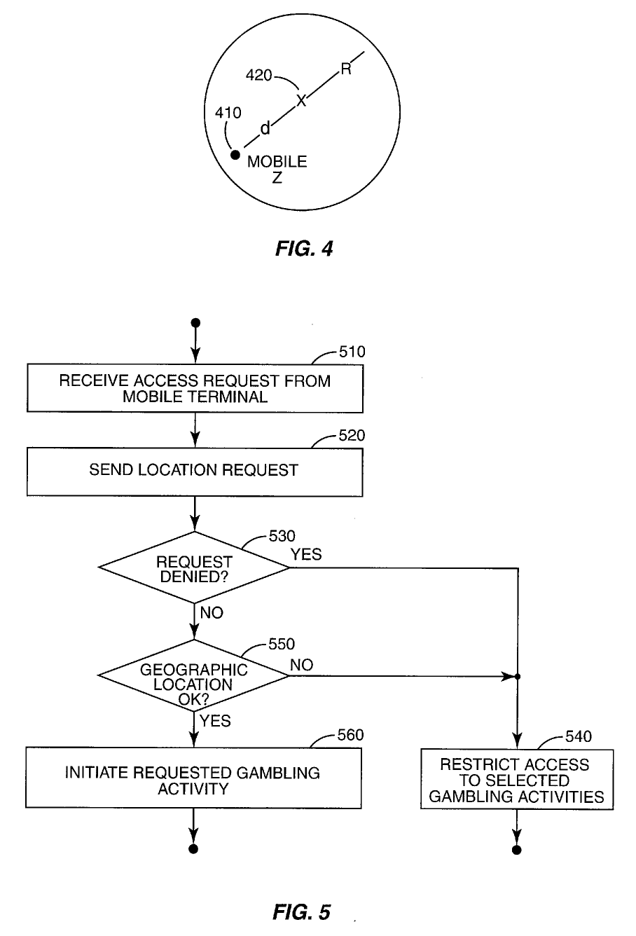

FIG. 5 thus illustrates a general method for controlling access to a gambling activity according to one or more embodiments of the current invention. At block 510, the method is initiated with an access request from mobile terminal 100 to a gambling activity hosted on game server 150. At block 520, after determining an identifier associated with the mobile terminal 100, game server 150 sends a location request to location server 160. Upon receiving a response, game server 150 checks whether the request was denied at block 530. If the request was denied, access to the gambling activity is denied at block 540. A message explaining the rejection might be sent to mobile terminal 100. Alternatively, access to other games or activities not subject to regulatory control might be permitted.

If the location request is not denied, then game server 150 receives geographic location information corresponding to mobile terminal 100 from location server 160. At block 550, game server 150 checks whether the location information is acceptable. As discussed above, game server 150 may compare the location information to jurisdictional boundary information and consult jurisdictional rules to determine whether access should be permitted. Alternatively, game server 150 may simply compare the location information to a pre-determined reference point to determine whether access should be granted.

If the location information is not acceptable, i.e. the mobile terminal 100 is not in an approved area, then access to the gambling activity is denied, or restricted, at block 530. If the mobile terminal 100 is in an approved area, on the other hand, then access to the gambling activity is granted at block 560.

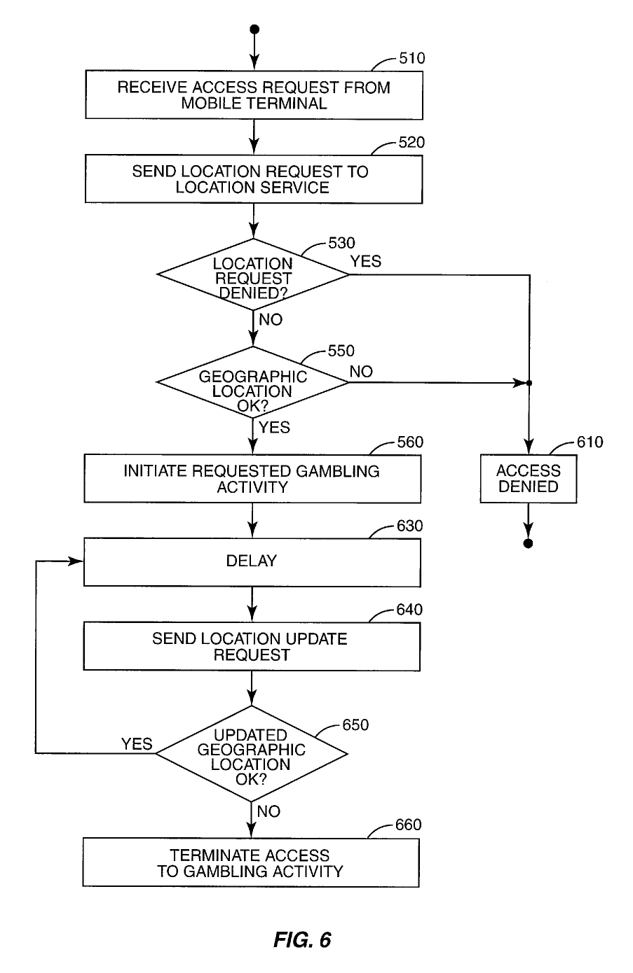

In a variation of the above method, the game server 150 periodically requests an updated location for mobile terminal 100, in order to determine whether the user remains within an approved area. This variation is illustrated in FIG. 6.

The method begins with an access request, at block 510, as in the previous method. At block 520, a location request is sent to location server 160. At block 530, game server 150 determines whether the request was denied; if so, then access to the gambling activity is denied at block 610.

At block 550, game server 150 validates the location of mobile terminal 100. If the location is acceptable, then access to the gambling activity is permitted at block 560. The user of mobile terminal 100 is thus permitted to initiate the requested gambling activity, and to repeat that activity or related activities.

After a pre-determined delay (block 630), which may range from a few seconds to many minutes, game server 150 sends a location update request to location server 160. This is illustrated at block 640. In response, game server 150 receives updated geographic location information, which is validated as before. If the updated location indicates that mobile terminal 100 is still within an approved area, then access to the gambling activity remains permitted and the user can continue with his gaming. This process is repeated periodically, to ensure that the mobile terminal 100 remains within approved areas.

If, on the other hand, the updated geographic location indicates that mobile terminal 100 has strayed from the approved area, then the gambling activity is terminated, as shown at block 660. Game server 150 may, of course, send an appropriate message to mobile terminal 100 explaining the termination.

In the event that access to a gambling activity is denied, whether in response to an initial access request, or because the mobile user has strayed from an approved area, game server 150 may be configured to provide compliance information to mobile terminal 100. In other words, rather than simply denying access to the gambling activity without explanation, game server may instruct the user of mobile terminal 100 as to the reasons for denial, and/or how to gain access to the restricted activity.

For example, if access is denied because the mobile terminal 100 is outside an approved area, game server 150 may provide directions to an approved area, or an address at which the requested activities are permitted. If game server 150 has obtained location information for mobile terminal 100, then these directions could comprise turn-by-turn navigation directions, at the street level, to the nearest approved area. These directions may be sent, for example, via a text message, multi-media message, or as a web page pushed to mobile terminal 100. The game server 150 may obtain these directions from location server or from a separate application server before sending them to mobile terminal 100. Alternatively, game server 150 may cause the directions to be sent to mobile terminal 100 directly from a separate application server.

Alternatively, if access is denied because the location request was rejected, game server 150 may send compliance information to mobile terminal 100 explaining the reason for the rejection. If, for example, location server 160 rejected the location request because the user of mobile terminal 100 had failed to authorize location requests, then game server 150 can provide mobile terminal 100 with instructions for authorizing subsequent requests. In some embodiments, location server 160 may require game server 150 to provide authorization information, such as an authorization code; in this event the compliance information sent to mobile terminal 100 may include a request for the appropriate authorization information.

A location request might also fail for technical reasons, in which case the compliance information sent to mobile terminal 100 may include instructions or suggestions for correcting the failure. For example, location information for mobile terminal 100 may be unavailable because of poor signal conditions. If location server 160 depends upon a GPS receiver in mobile terminal 100, for example, then a position determination may be impossible if the mobile terminal 100 is attempting access from a parking garage or other location with an obstructed view of the sky. Information returned to game server 150 explaining the failure may be used to generate compliance information to assist the user of mobile terminal 100 in seeking out more favorable conditions.

In yet another embodiment, game server 150 may follow up a denial of access to a requested gambling activity with suggestions for other activities that are permitted at the mobile terminal 100 user's location. These other activities might be games that do not involve gambling. Alternatively, if a jurisdiction permits some gambling activities but bans others, then game server 150 may suggest permitted activities. The compliance information may thus comprise a hyperlink, selectable menu items, or other indicator associated with one or more of these alternative activities.

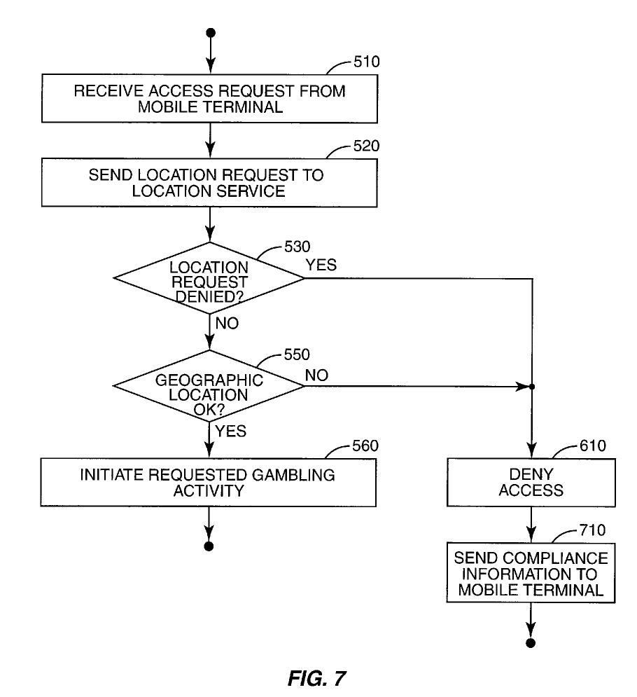

An exemplary method embodying the above embodiment is illustrated at FIG. 7. At blocks 510, 520, 530, 550, 560, and 610, access to a requested gambling activity is selectively granted or denied, based on a response to a location request, as previously explained. However, in the event that access to a requested gambling activity is denied, at block 610, then game server 150 sends compliance information to mobile terminal 100. This is illustrated at block 710.

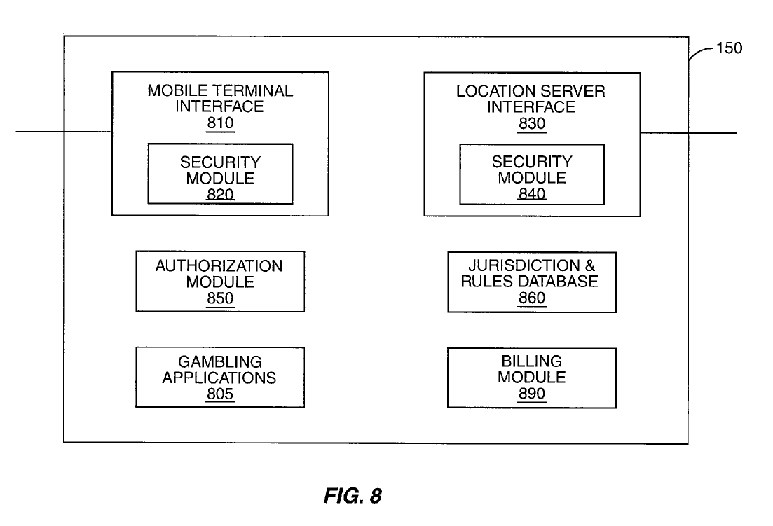

FIG. 8 illustrates functional aspects of a game server 150 in accordance with one or more embodiments of the present invention. Game server 150 hosts one or more gambling activities, represented by block 805. Game server 150 further comprises a mobile terminal interface 810, which may include a security module 820, and a location server interface 830, which may also include a security module 840. Game server 150 further comprises an authorization module 850 and a jurisdiction/rules database 860, as well as a billing module 890.

Game server 150 is described here in terms of its functional elements only. Those skilled in the art will recognize the variety of software and hardware configurations available for implementing the described functions. These functions may reside on a single computer, or be distributed across several computers. Similarly, game server 150 may comprise software running on a stand-alone computer, or may reside on a computer with numerous other server applications. Again, those skilled in the art will readily appreciate the range of possible implementations, and the advantages and disadvantages accruing from each.

Mobile terminals communicate with game server 150 through mobile terminal interface 810. Mobile terminal interface 810, in one or more embodiments, is accessed using an Internet address. In this event, mobile terminal interface 810 may also be used by devices other than mobile terminals, e.g. personal computers on the Internet. In some embodiments, mobile terminal interface 810 may not be directly accessible, but may be accessible only through one or more proxy servers. In other embodiments, access to mobile terminal interface 810 is exclusive to a mobile gateway, such as a WAP gateway, maintained by a mobile operator. In either event, mobile terminal interface 810 may optionally comprise a security module 820, which provides for encryption and/or authentication of messages sent between mobile terminal 100 and game server 150.

Location server interface 830 is used for communication with location server 160. This interface may simply be an interface to the Internet, or it may be a dedicated interface. Location server interface 830 may also comprise a security module 840, which provides encryption and/or authentication for messages sent between game server 150 and location server 160.

Authorization module 850 is used to determine whether the user of mobile terminal 100 should be granted access to gambling applications 805. Authorization module 850 may be configured to authenticate the user of mobile terminal 100, using a username and password, for example. In response to an access request from mobile terminal 100, authorization module 850 also assembles a location request, containing an identifier for mobile terminal 100, and sends the request to location server 160 using location server interface 830. Location requests may optionally be encrypted using security module 840.

Upon receiving geographic location information (which may need to be decrypted by security module 840) from location server 160, authorization module 150 compares the received geographic location information to jurisdiction information and/or rules contained in the jurisdiction/rules database 860. Any or several of the methods described above may be used to determine whether access to the requested gambling activity should be granted. If the location information indicates that mobile terminal 100 is located in an approved area, then mobile terminal 100 is allowed to access gambling applications 805 via mobile terminal interface 810. As described above, the authorization process may be repeated at intervals to determine whether mobile terminal 100 remains within an approved area.

Finally, billing module 890 tracks the gambling activities accessed by mobile terminal 100, and tallies the associated winnings or losses. Billing module 890 may credit/debit a pre-paid account, or post transactions to a credit card account. Alternatively, micro-wagers (bets involving relatively small sums of money) might be credited or debited against a mobile phone account, so that the winnings or losses appear on a monthly statement from the mobile phone operator. Billing module 890 may thus communicate with banking systems, credit card systems, or wireless operator billing systems, using interfaces (not shown) standard in those industries and well known to those skilled in the art.

Those skilled in the art should appreciate that the present invention broadly provides methods and apparatus for controlling access to gambling activities based on the location of a mobile terminal. The present invention may, of course, be carried out in other specific ways than those herein set forth without departing from the scope and essential characteristics of the invention. Thus, the present invention is not limited to the features and advantages detailed in the foregoing description, nor is it limited by the accompanying drawings. Indeed, the present invention is limited only by the following claims, and their legal equivalents.

What is claimed is:

1. A method for controlling access to an online gambling activity, comprising:
receiving an access request from a mobile terminal, the mobile terminal having an associated identifier;
sending a location request comprising the identifier to a location service; and
selectively initiating an online gambling activity based on a response to the location request.

2. The method of claim 1, wherein the response comprises geographic location information and wherein selectively initiating an online gambling activity based on the response comprises selectively initiating the online gambling activity based on comparing the geographic location information to jurisdictional boundaries.

3. The method of claim 1, wherein the response comprises geographic location information and wherein selectively initiating an online gambling activity based on the response comprises selectively initiating the online gambling activity based on a distance between a point designated by the geographic location information and a predetermined reference point.

4. The method of claim 1, wherein the response comprises geographic location information, further comprising restricting access to selected gambling activities based on the geographic location information.

5. The method of claim 1, further comprising:
sending a location update request after a predetermined interval of time; and
selectively terminating the online gambling activity based on a location update response to the location update request.

6. The method of claim 1, wherein selectively initiating an online gambling activity comprises denying access to the online gambling activity based on the response, and further comprising sending compliance information to the mobile terminal.

7. The method of claim 6, wherein the compliance information comprises directions to an alternate location where access to the online gambling activity is permitted.

8. The method of claim 6, wherein the compliance information comprises an indicator associated with an alternative online activity permitted at the mobile terminal's current location.

9. The method of claim 6, wherein the response comprises an indication that the location request is unauthorized, and wherein sending compliance information to the mobile terminal comprises requesting authorization information from the mobile terminal.

10. The method of claim 6, wherein the response comprises an indication that the location request failed, and wherein sending compliance information to the mobile terminal comprises sending a suggestion for correcting the failure.

11. A game server configured to:
receive an access request from a mobile terminal having an associated identifier;
determine the identifier associated with the mobile terminal;
send a location request comprising the identifier to a location server; and
selectively initiate an online gambling activity with the mobile terminal based on a response to the location request.

12. The game server of claim 11, wherein the game server is further configured to compare geographic location information included in the response to jurisdictional boundaries and to selectively initiate the online gambling activity based on said comparison.

13. The game server of claim 11, wherein the game server is further configured to determine a distance between a predetermined reference point and a geographic location designated by the response to the location request, and to selectively initiate the online gambling activity based on the distance.

14. The game server of claim 11, wherein the game server is further configured to restrict access to selected gambling activities based on geographic location information included in the response to the location request.

15. The game server of claim 11, wherein the game server is further configured to:
send a location update request after a predetermined interval of time; and
selectively terminate the online gambling activity based on a location update response to the location update request.

16. The game server of claim 11, wherein the game server is further configured to send compliance information to the mobile terminal based on the response to the location request.

17. The game server of claim 16, wherein the compliance information comprises directions to an alternate location where access to the online gambling activity is permitted.

18. The game server of claim 16, wherein the compliance information comprises an indicator associated with an alternative online activity permitted at the mobile terminal's current location.

19. The game server of claim 16, wherein the response comprises an indication that the location request is unauthorized, and wherein sending compliance information to the mobile terminal comprises requesting authorization information from the mobile terminal.

20. A wireless gambling system, comprising:
a mobile terminal having an associated identifier and configured to request access to an online gambling activity;
a location server configured to:
receive a location request identifying a mobile terminal;
determine geographic location information for the mobile terminal; and
respond to the location request with the geographic location information; and
a game server configured to:
receive an access request from the mobile terminal;
determine the identifier associated with the mobile terminal;
send a location request comprising the identifier to the location server;
receive the geographic location information; and
selectively initiate an online gambling activity with the mobile terminal based on the geographic location information.
